(19) United States
(12) Patent Application Publication
(10) Pub. No.: US 2026/0188638 A1
(43) Pub. Date: Jul. 2, 2026

(54) QUADRUPOLE MASS ANALYZING APPARATUS

(71) Applicant: HORIBA STEC, Co., Ltd., Kyoto (JP)

(72) Inventors: Shiho MIYABAYASHI, Kyoto (JP); Kazushi SASAKURA, Kyoto (JP); Rena YAMAKAWA, Kyoto (JP); Sotaro KISHIDA, Kyoto (JP); Hiroshi TAKAKURA, Kyoto (JP); Hiroyuki SEKI, Kyoto (JP)

(73) Assignee: HORIBA STEC, Co., Ltd., Kyoto (JP)

(21) Appl. No.: 19/416,183

(22) Filed: Dec. 11, 2025

(30) Foreign Application Priority Data
Dec. 26, 2024 (JP) 2024-230322

(51) Int. Cl. H01J 49/42; H01J 49/14

(52) U.S. Cl. CPC H01J 49/4215; H01J 49/147

(57) ABSTRACT

An ion source of a quadrupole mass analyzing apparatus includes: a filament that emits electrons when a voltage is applied to the filament; an ionization box that ionizes a sample when electrons enter the ionization box; and a blocking member that is placed between the filament and the ionization box, and blocks a film-forming material from moving toward the ionization box, the film-forming material being to form a film in the ionization box.

### CROSS-REFERENCE TO RELATED APPLICATION

The present application claims priority of Japanese Application No. 2024-230322, filed on Dec. 26, 2024, the entire contents of which are hereby incorporated by reference in their entireties.

### BACKGROUND OF THE INVENTION

### 1. Technical Field

The present invention relates to a quadrupole mass analyzing apparatus.

### 2. Description of the Related Art

There is a conventional quadrupole mass analyzing apparatus that includes an ionization unit that ionizes a sample as disclosed in JP 2017-107816 A, for example. The ionization unit includes: a filament that has a coil-like shape, and emits electrons when a voltage is applied thereto; and a grid electrode (hereinafter also referred to as the ionization box) that receives the electrons emitted from the filament, and ionizes a sample by causing the electrons to collide with the sample.

The ionized sample is released from the ionization box to a quadrupole unit, and is separated by the quadrupole unit. On the other hand, the electrons collide with the ionization box, and the voltage to be applied to the filament is controlled on the basis of the electric current generated by the electrons colliding at that point of time.

### Prior Art Document

### Patent Document

Patent Document 1: JP 2017-107816 A

### SUMMARY OF THE INVENTION

Meanwhile, when mass analysis of a sample is performed in the above mass analyzing apparatus, the material forming the filament may react to generate molecules serving as a factor of forming a film in the ionization box. If the molecules enter the ionization box, a film will be formed in the ionization box.

In this case, the film inhibits electrons from colliding directly with the ionization box, and therefore, there is a possibility that a voltage excessive relative to the number of electrons in the ionization box will be applied to the filament. As a result, the filament will break earlier than expected, and the filament cannot be used for a long time.

Therefore, the present invention has been made in view of the above problem, and a principal objective thereof is to use the filament for a longer time by preventing formation of a film in the ionization box.

That is, a quadrupole mass analyzing apparatus according to the present invention characteristically includes: an ion source that ionizes a sample; a filter unit that separates ions generated at the ion source with a quadrupole; and a detection unit that detects the ions separated by the filter unit, in which the ion source includes: a filament that emits electrons when a voltage is applied to the filament; an ionization box that ionizes the sample when the electrons enter the ionization box; and a blocking member that is disposed between the filament and the ionization box, and blocks a film-forming material from moving from the filament toward the ionization box, the film-forming material being to form a film in the ionization box.

In the quadrupole mass analyzing apparatus according to the present invention, the blocking member is placed between the filament and the ionization box, and blocks the film-forming material from moving from the filament toward the ionization box. Thus, it is possible to prevent film formation in the ionization box. As a result, in a case where the voltage of the filament is controlled on the basis of the electric current generated by the electrons colliding with the ionization box, for example, the voltage of the filament can be appropriately controlled, and the filament can be used longer than in conventional cases.

If a film is formed in the ionization box, the number of electrons colliding directly with the ionization box is reduced. Therefore, there is a possibility that a voltage excessive relative to the number of electrons in the ionization box will be applied to the filament. As a result, the life of the filament will be shortened.

Therefore, the quadrupole mass analyzing apparatus may further include a voltage control unit that controls the voltage to be applied to the filament, on the basis of the electric current generated by the electrons colliding with the ionization box.

With this configuration, formation of a film in the ionization box is prevented by the blocking member, and thus, the electric current generated by the electrons colliding with the ionization box appropriately reflects the number of electrons in the ionization box. Accordingly, the voltage control unit can appropriately control the voltage to be applied to the filament, on the basis of the electric current generated by the electrons colliding with the ionization box.

The quadrupole mass analyzing apparatus may further include a low potential member that is open toward the ionization box, surrounds the filament, and has a lower potential than the potential of the ionization box, the blocking member covering part of the opening of the low potential member.

With this configuration, the electrons generated from the filament can be directed toward the ionization box through the opening of the low potential member. Thus, even in a case where the blocking member is interposed between the filament and the ionization box, electrons can be made to enter the ionization box from the filament.

The blocking member may be attached to the low potential member.

With this configuration, the blocking member is attached to the low potential member, and thus, assembly of the ion source is facilitated.

Furthermore, as the blocking member has the same potential as the potential of the low potential member, it is easy to adjust the potential of the blocking member.

The potential of the ionization box may be higher than the potential of the filament, and the potential of the blocking member may be equal to or lower than the potential of the filament.

With this configuration, electrons generated from the filament are easily directed toward the ionization box.

The ionization box may include: a first surface in which an ion emission opening that emits generated ions to the filter unit is formed; and a second surface in which an electron entrance opening that is not a portion facing the first surface and through which electrons generated from the filament enter is formed, the filament may be disposed to face the electron entrance opening, and the blocking member may cover part of the filament from the side opposite to the ion emission opening.

With this configuration, the blocking member covers part of the filament from the side opposite to the ion emission opening, and thus, electrons generated from the filament are easily guided to a position close to the ion emission opening in the ionization box. Accordingly, even in a case where the blocking member is interposed between the filament and the ionization box, the sample can be ionized at a position close to the ion emission opening in the ionization box, and the ions can be guided to the filter unit.

The blocking member may cover at least half of the filament as viewed from the ionization box.

With this configuration, the blocking member can block most of the film-forming material, and can further prevent contamination of the ionization box.

According to the present invention, film formation in the ionization box is prevented, and thus, the filament can be used longer.

### BRIEF DESCRIPTION OF THE DRAWINGS

FIG. 1 is a schematic diagram illustrating a state in which a quadrupole mass analyzing apparatus according to an embodiment of the present invention is attached to a chamber;

FIG. 2 is a diagram schematically illustrating the configuration of the quadrupole mass analyzing apparatus of the embodiment;

FIG. 3 is an enlarged view of the portion surrounded by a dashed line in FIG. 2;

FIG. 4 is a diagram illustrating a blocking member and the like in a top view of the embodiment;

FIG. 5 is an enlarged view of the portion surrounded by a dashed line portion in FIG. 2, and is a diagram illustrating movement of a film-forming material and electrons; and

FIG. 6 is a graph showing comparison between the life of a filament of the present invention and the life of a filament of a conventional example.

### DETAILED DESCRIPTION

### One Embodiment of the Present Invention

In the following, a quadrupole mass analyzing apparatus according to an embodiment of the present invention is described with reference to the drawings. Note that, for easier understanding, any of the drawings described below is schematically drawn, with some portions omitted or exaggerated as appropriate. The same components are denoted by the same reference numerals, and explanation thereof will be omitted as appropriate.

### Apparatus Configuration

The quadrupole mass analyzing apparatus 100 according to the present embodiment is attached to a chamber C or the like, for example, and analyzes a sample in the chamber C. Note that a gas such as a fluorine-based corrosive gas is introduced into the chamber C, for example.

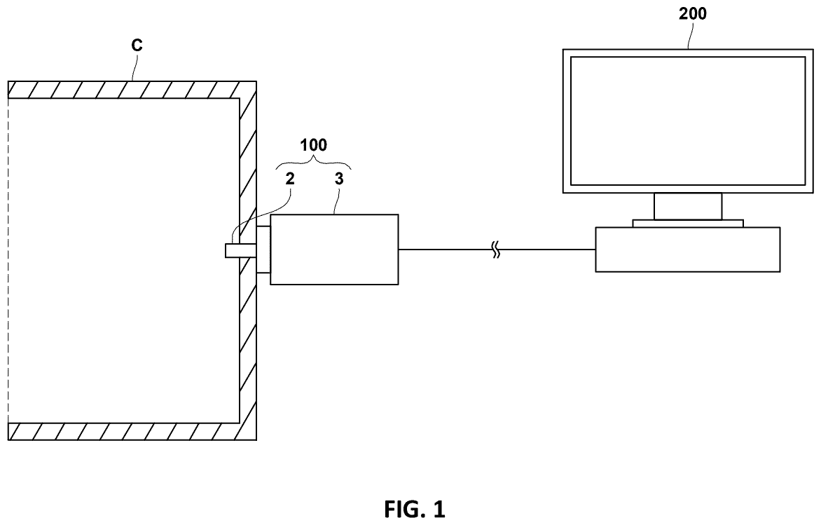

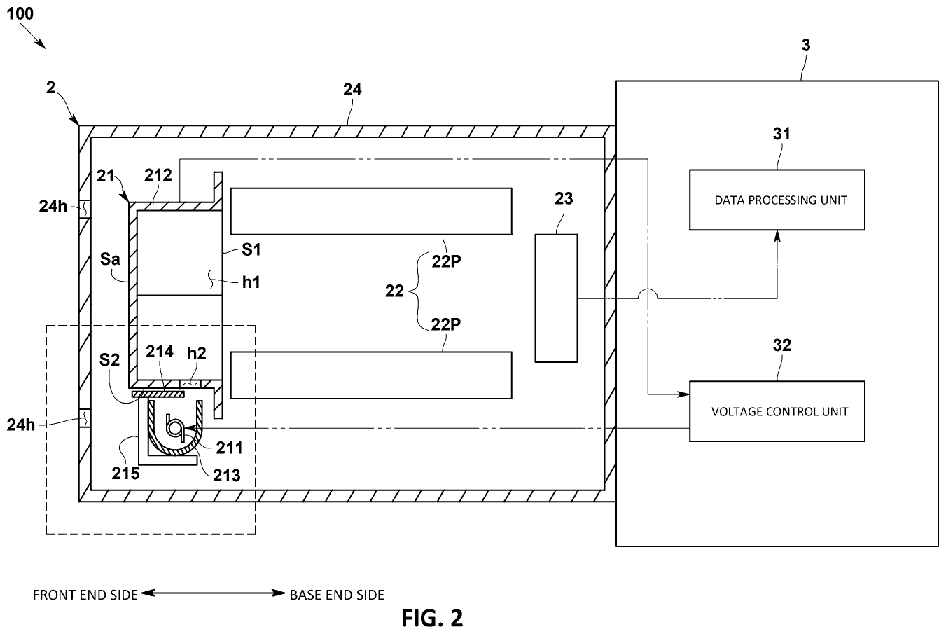

Specifically, as illustrated in FIGS. 1 and 2, the quadrupole mass analyzing apparatus 100 includes a sensor unit 2 that detects a sample in the chamber C, and an arithmetic control unit 3 that controls the sensor unit 2 and performs analytical processing and the like on the sample on the basis of an output from the sensor unit 2. In the following, the sensor unit 2 is described first, followed by the arithmetic control unit 3.

As illustrated particularly in FIG. 2, the sensor unit 2 includes: an ion source 21 that ionizes a sample; a filter unit 22 that separates ions generated in the ion source 21 with quadrupoles; a detection unit 23 that detects the ions separated by the filter unit 22; and a casing 24 that houses the ion source 21, the filter unit 22, and the detection unit 23. Because the present embodiment is characterized by the ion source 21, the ion source 21 will be described after the filter unit 22, the detection unit 23, and the casing 24 are described first.

The filter unit 22 separates an ion beam emitted from the ion source 21, depending on a charge-to-mass ratio (m/z) of ions. Specifically, the filter unit 22 includes two pairs of counter electrodes 22P that are arranged at intervals of 90° and have a columnar shape. Note that, in the present embodiment, the filter unit 22 includes one set of two pairs of counter electrodes 22P, which are four counter electrodes 22P, but may have a plurality of sets of two pairs of counter electrodes 22P, which are five or more counter electrodes 22P.

In the two pairs of counter electrodes 22P, an incident filter voltage that is a voltage generated by superimposing a direct-current voltage U and a high-frequency voltage V on each other is applied between the respective sets arranged at intervals of 90°, by a voltage application unit (not shown), with the opposing electrodes having the same potential. The incident filter voltage is swept so that ions pass through a stable region that is a set of a direct-current voltage U and a high-frequency voltage V that can pass through the filter unit 22 and reach the detection unit 23. Thus, the ions that have entered the counter electrodes 22P selectively pass depending on the charge-to-mass ratio (m/z).

The detection unit 23 is a Faraday cup or the like that captures ions separated by the filter unit 22 and detects the ions as an ionic current, for example. Specifically, the detection unit 23 detects ions of specific components separated by the filter unit 22. The current value of the ionic current detected by the detection unit 23 is output to a data processing unit 31 that will be described later. Note that the detection unit 23 may detect all the ions of the sample ionized by the ion source 21.

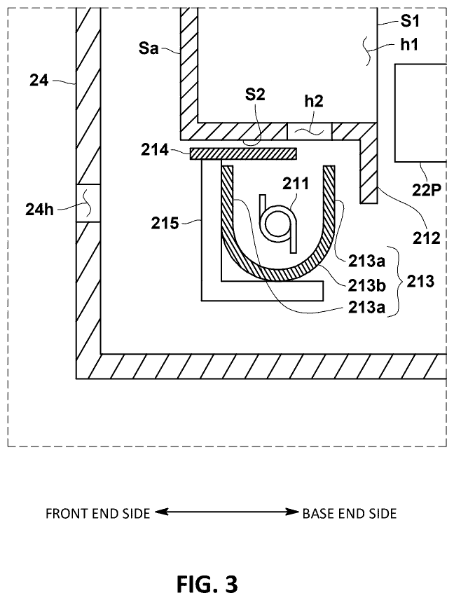

The casing 24 houses the ion source 21, the filter unit 22, and the detection unit 23 in this order from the front end side. The casing 24 has a cylindrical shape, for example, but is not limited to any particular shape, as long as it has an internal space capable of housing the ion source 21, the filter unit 22, and the detection unit 23. Hereinafter, in the axial direction of the casing 24, the side on which the ion source 21 is disposed will be referred to as the front end side, and the side on which the detection unit 23 is disposed will be referred to as the base end side, as shown in FIGS. 2 and 3. The front end wall of the casing 24 has a sample introduction port 24h for introducing a sample in the chamber C into the sensor unit 2 when the casing 24 is attached to the chamber C. Note that the casing 24 is airtightly attached to an attachment hole formed in the chamber C via a sealing member or the like. As a result, the pressure in the casing 24 becomes the same as the atmospheric pressure in the chamber C via the sample introduction port 24h, and the ion source 21, the filter unit 22, and the detection unit 23 are exposed to the atmospheric pressure in the chamber C.

As illustrated particularly in FIGS. 2 and 3, the ion source 21 includes: a filament 211 to which a voltage is applied and which emits electrons; an ionization box 212 into which electrons from the filament 211 are introduced and which ionizes a sample; a low potential member 213 having a lower potential than the potential of the ionization box 212; and a blocking member 214 disposed between the filament 211 and the ionization box 212.

The filament 211 has a coil-like shape, and an end thereof is connected to a power supply (not shown). The filament 211 is heated and emits electrons when a voltage is applied thereto. Note that the filament 211 is formed with iridium coated with yttrium oxide (Y₂O₃), for example.

Electrons generated from the filament 211 enter the ionization box 212, and the electrons colliding with the sample therein ionize the sample, so that the ions are emitted. Here, the ionization box 212 has a hexagonal columnar and tubular shape. However, the ionization box 212 does not necessarily have this shape, and may have a tubular shape such as a circular shape or another polygonal shape and/or a conical shape. Also, the ionization box 212 is connected to a power supply (not shown), and is controlled to have a higher potential (70 V or the like, for example) than that of the filament 211.

Specifically, the ionization box 212 has a first surface S1 in which an ion emission opening h1 for emitting generated ions to the filter unit 22 is formed, and a second surface S2 that is a surface other than the opposing surface Sa facing the first surface S1 and in which an electron entrance opening h2 through which electrons generated from the filament 211 enter is formed. Note that an opening (not shown) for introducing a sample into the ionization box 212 is formed in the opposing surface Sa.

As illustrated particularly in FIGS. 2 and 3, the first surface S1 is placed to face one axial end of each counter electrode 22P. The ion emission opening h1 is open toward the counter electrodes 22P, and is also open from the first surface S1 toward an inner wall of the casing 24.

As illustrated particularly in FIGS. 2 and 3, the second surface S2 is a surface adjacent to the first surface S1, and constitutes a side peripheral surface of the ionization box 212 herein. The electron entrance opening h2 that has a slit-like shape is formed in the second surface S2, and the electron entrance opening h2 is open toward the filament 211. Specifically, the filament 211 extending in a coil-like shape is disposed outside the ionization box 212 along the second surface S2, and the filament 211 is placed to face the electron entrance opening h2. Note that the electron entrance opening h2 does not necessarily have a slit-like shape, and the rim of the opening may have a circular shape or some other polygonal shape.

The low potential member 213 is controlled to have a lower potential than that of the ionization box 212. Here, the low potential member 213 is controlled to have a predetermined potential such as 0 V, for example, via a support member 215 that will be described later, but the low potential member 213 may be directly controlled to have a predetermined potential.

In the present embodiment, the low potential member 213 has a shape obtained by dividing a tubular shape in the axial direction, and surrounds the filament 211. Specifically, as illustrated particularly in FIG. 3, the low potential member 213 includes: a pair of sidewall portions 213a placed to face each other with the filament 211 interposed therebetween; and a bottom wall portion 213b that covers the filament 211 at a portion on the opposite side to the second surface S2 and is connected to one end portion of each sidewall portion 213a. With such a configuration, the filament 211 in the portion facing the second surface S2 is not covered with the low potential member 213. Here, one sidewall portion 213a of the one pair of sidewall portions 213a is placed on the front end side of the other sidewall portion 213a, and the other sidewall portion 213a is placed on the side of the ion emission opening h1, compared with the one sidewall portion 213a.

Also, as illustrated particularly in FIGS. 2 and 3, the low potential member 213 is open toward the ionization box 212. Specifically, the low potential member 213 is disposed along the second surface S2, and the one pair of sidewall portions 213a defines its opening width. The opening of the low potential member 213 is formed to face the electron entrance opening h2.

Meanwhile, the blocking member 214 blocks a film-forming material forming a film in the ionization box 212 from moving toward the ionization box 212. The film-forming material mentioned herein is molecules generated by a reaction between the filament 211 and a gas, and forms an insulating film in the ionization box 212. The film-forming material is directed from the filament 211 toward the ionization box 212. For example, the film-forming material is yttrium fluoride (YF₃) generated by a reaction between the yttrium oxide constituting the filament 211 and a fluorine-based corrosive gas.

As illustrated in FIGS. 2 to 4, the blocking member 214 has a flat plate-like shape, for example, and covers part of the opening of the low potential member 213. Specifically, the blocking member 214 forms a predetermined gap with the sidewall portion 213a disposed on the side of the ion emission opening h1. Accordingly, the blocking member 214 covers the front end side portion of the opening of the low potential member 213. Note that the shape of the blocking member 214 is not necessarily a flat plate-like shape, and may be any shape that covers part of the opening of the low potential member 213. Also, the blocking member 214 may be placed so as to block at least one of the straight lines extending from the filament 211 to the ionization box 212.

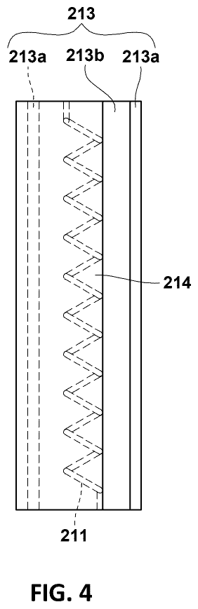

Further, the blocking member 214 is disposed between the filament 211 and the second surface S2, and covers part of the filament 211 from the opposite side to the ion emission opening h1. Specifically, the blocking member 214 covers the front end side portion of the opening of the low potential member 213, so that the blocking member 214 covers the portion of the filament 211 on the opposite side to the ion emission opening h1. Note that, in FIG. 4, the blocking member 214 covers the portion of the filament 211 facing the second surface S2, but preferably covers at least half or more of the portion of the filament 211 facing the second surface S2. More specifically, the blocking member 214 is only required to cover half or more of the front end side portion of the portion of the filament 211 facing the second surface S2.

Further, the blocking member 214 is attached to the low potential member 213. In the present embodiment, as illustrated particularly in FIGS. 2 and 3, a support member 215 that supports the blocking member 214 is attached to the low potential member 213, and the blocking member 214 is positioned between the low potential member 213 and the second surface S2 via the support member 215. Note that the blocking member 214 and the support member 215 are an integrated member in the present embodiment, but may be separate members.

Also, the support member 215 is controlled to have a predetermined potential such as 0 V, for example, by a control device (not shown). Further, as the low potential member 213 is attached to the support member 215, the potential of the support member 215 and the potential of the low potential member 213 are the same. Furthermore, as the blocking member 214 is attached directly to the support member 215, the potential of the blocking member 214 is also the same as the potential of the low potential member 213. Note that the potential of the support member 215 is only required to be controlled to be at least equal to or lower than the potential of the filament 211.

The arithmetic control unit 3 includes an A/D converter, a D/A converter, a CPU, a memory, a communication port, and the like. The arithmetic control unit 3 includes: a data processing unit 31 that performs mass analysis on the basis of the current value of an ionic current that is output from the detection unit 23 of the sensor unit 2; and a voltage control unit 32 that controls a voltage to be applied to the filament 211, on the basis of the current generated by electrons colliding with the ionization box 212. Also, if necessary, the data processing unit 31 can transmit a result of the analysis to the general-purpose computer 200 (see FIG. 1) or the like.

### Actions of Blocking Member 214

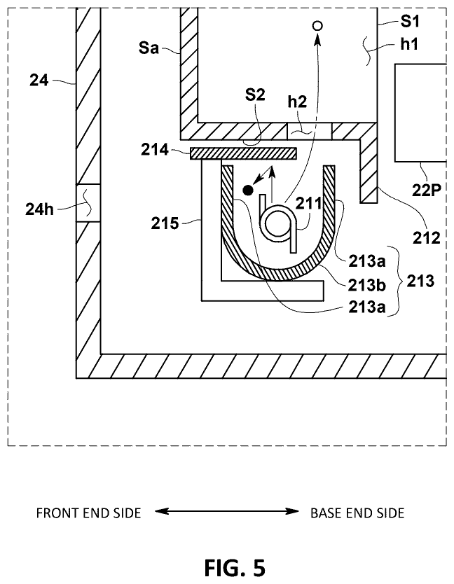

Next, the actions of the blocking member 214 of the present embodiment are described with reference to FIG. 5.

Through the voltage control performed by the voltage control unit 32, a voltage is applied to the filament 211 and heats the filament 211, so that electrons (a white circle in FIG. 5) are emitted from the filament 211.

The electrons move toward the ionization box 212 controlled to have a higher potential than the potentials of the low potential member 213 and the blocking member 214. Specifically, the electrons pass through the electron entrance opening h2 from a predetermined gap formed between the sidewall portion 213a placed on the side of the ion emission opening h1 and the blocking member 214, and enter the ionization box 212.

Inside the ionization box 212, the sample is ionized by the collision between the electrons and the sample. The ionized sample is released into the filter unit 22 through the ion emission opening h1, and is separated in the filter unit 22 depending on the mass-to-charge ratio. The electrons collide with the inner walls of the ionization box 212, without moving to the filter unit 22.

On the other hand, in the fluorine-based corrosive gas environment, for example, the material constituting the filament 211 reacts with the corrosive gas, to generate the film-forming material (a black circle in FIG. 5). Having no electric charge, the film-forming material linearly moves from the filament 211 toward the second surface S2. Since the blocking member 214 is placed between the filament 211 and the second surface S2, the film-forming material collides with the blocking member 214, and thus, the film-forming material is prevented from moving into the ionization box 212.

Because of this, the formation of a coating film on the inner walls of the ionization box 212 is prevented, and thus, a current generated by electrons colliding with the ionization box 212 is appropriately generated in accordance with the number of electrons in the ionization box 212. As a result, the voltage control unit 32 can appropriately control the voltage to be applied to the filament 211, on the basis of the current generated by the electrons colliding with the ionization box 212.

### Comparison between Present Embodiment and Conventional Example

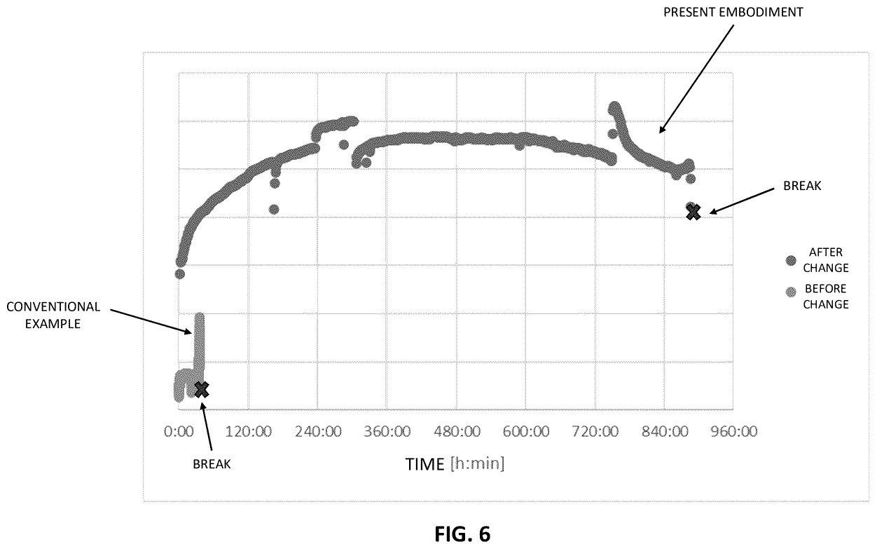

Next, a comparison between the life of the filament 211 of the present embodiment and the life of a filament of a conventional example is described with reference to FIG. 6.

In a case where the blocking member 214 was disposed above the filament 211 as described in the present embodiment, the life of the filament 211 lasted about 900 hours as shown in FIG. 6. On the other hand, in a case where the blocking member 214 was not disposed above the filament 211 as in the conventional example, the filament was broken in about 40 hours as shown in FIG. 6.

### Effects of Present Embodiment

In the quadrupole mass analyzing apparatus 100 according to the present embodiment, the blocking member 214 is placed between the filament 211 and the ionization box 212, and blocks the film-forming material from moving toward the ionization box 212. Thus, it is possible to prevent film formation in the ionization box 212. As a result, in a case where the voltage of the filament 211 is controlled on the basis of the current generated by electrons colliding with the ionization box 212, for example, the voltage of the filament 211 can be appropriately controlled, and the filament 211 can be used longer than in conventional cases.

### Other Embodiments

Note that the present invention is not limited to the above embodiment.

In the above embodiment, the blocking member 214 forms the predetermined gap with the sidewall portion 213a provided on the side of the ion emission opening h1. However, the blocking member 214 may form the predetermined gap with the sidewall portion 213a provided on the inner wall side of the casing 24.

In the above embodiment, the blocking member 214 is attached to the low potential member 213 via the support member 215. However, the present invention is not limited to this. For example, the blocking member 214 may be attached directly to the low potential member 213, or may be attached to the inner wall of the casing 24 and cover part of the opening of the low potential member 213 from the inner wall of the casing 24.

In the above embodiment, a plurality of filaments 211 may be provided. In this case, low potential members 213 and blocking members 214 are provided depending on the number of the filaments 211.

In the above embodiment, in a case where the electron entrance opening h2 has a slit-like shape, the direction in which the slit-like shape extends may be a direction along the direction in which the filament 211 extends, or may be a direction intersecting the direction in which the filament 211 extends.

In the above embodiment, the ion source 21 is included in the quadrupole mass analyzing apparatus 100. However, the ion source 21 may be included in an analyzing apparatus that ionizes a sample with electrons, such as an ion trap mass analyzing apparatus, a time-of-flight mass analyzing apparatus, a double-focusing mass analyzing apparatus, or a tandem mass analyzing apparatus, for example.

In addition to the above, the present invention can be variously modified without departing from the spirit of the invention.

### INDUSTRIAL APPLICABILITY

According to the present invention, film formation in the ionization box is prevented, and thus, the filament can be used longer.

### REFERENCE SIGNS LIST

100: quadrupole mass analyzing apparatus
2: sensor unit
21: ion source
211: filament
212: ionization box
213: low potential member
214: blocking member
22: filter unit
23: detection unit
3: arithmetic control unit
31: data processing unit
32: voltage control unit
S1: first surface of ionization box
S2: second surface of ionization box
h1: ion emission opening
h2: electron entrance opening

What is claimed is:

1. A quadrupole mass analyzing apparatus comprising:
an ion source that ionizes a sample;
a filter unit that separates ions generated at the ion source with a quadrupole; and
a detection unit that detects the ions separated by the filter unit,
wherein the ion source includes:
a filament that emits electrons when a voltage is applied to the filament;
an ionization box that ionizes the sample when the electrons enter the ionization box; and
a blocking member that is disposed between the filament and the ionization box, and blocks a film-forming material from moving from the filament toward the ionization box, the film-forming material being to form a film in the ionization box.

2. The quadrupole mass analyzing apparatus according to claim 1, further comprising a voltage control unit that controls a voltage to be applied to the filament, on a basis of an electric current generated by the electrons colliding with the ionization box.

3. The quadrupole mass analyzing apparatus according to claim 1, further comprising a low potential member that is open toward the ionization box, surrounds the filament, and has a lower potential than a potential of the ionization box,
wherein the blocking member covers part of the opening of the low potential member.

4. The quadrupole mass analyzing apparatus according to claim 3, wherein the blocking member is attached to the low potential member.

5. The quadrupole mass analyzing apparatus according to claim 1,
wherein a potential of the ionization box is higher than a potential of the filament, and
a potential of the blocking member is not higher than the potential of the filament.

6. The quadrupole mass analyzing apparatus according to claim 1,
wherein the ionization box includes:
a first surface in which an ion emission opening that emits the generated ions to the filter unit is formed; and
a second surface in which an electron entrance opening that is not a portion facing the first surface and through which the electrons generated from the filament enter is formed,
the filament is disposed to face the electron entrance opening, and
the blocking member covers part of the filament from a side opposite to the ion emission opening.

7. The quadrupole mass analyzing apparatus according to claim 1, wherein the blocking member covers at least half of the filament as viewed from the ionization box.
